(19) United States
(12) Patent Application Publication
(10) Pub. No.: US 2005/0083627 A1
(43) Pub. Date: Apr. 21, 2005

(54) Hybrid parallel active power filter for electrified railway system

(76) Inventors: Yue Wang, Xi'an (CN); Zhao'an Wang, Xi'an (CN); Jun Yang, Xi'an (CN); Yong Duan, Xi'an (CN); Zhiping Fu, Xi'an (CN); Yahan Hua, Xi'an (CN)

Correspondence Address: DORSEY & WHITNEY LLP;INTELLECTUAL PROPERTY DEPARTMENT, 250 PARK AVENUE, NEW YORK, NY, 10177, US

(21) Appl. No.: 10/951,996

(22) Filed: Sep. 27, 2004

(30) Foreign Application Priority Data
Sep. 25, 2003 (CN) 03134614.6

(51) Int. Cl. H02H 1/00

(52) U.S. Cl. 361/113; 307/105

(57) ABSTRACT

An exemplary parallel hybrid power filter apparatus for the electrified railway is described. The apparatus may include a group of LC reactive filter being purely tuned, an additional inductance, an active power filter and a coupling transformer. The active power filter may be controlled, e.g., as a current source in a composite control manner and can be connected in parallel to the additional inductance via the coupling transformer. The power filter can be connected to the reactive filter in series to form the parallel hybrid filtering system, and may be connected to the power grid via the circuit breaker or a thyristor. This exemplary system can be installed either in the traction substations or in the locomotives directly, or performed by ameliorating the original reactive filter. The active power filter does not add significant amount of cost, and may be simple and reliable in a control manner for the capacity of the APF is so small as to be less than one percent of that of the harmonics source. The power filter can also inhibit the impact of the “background harmonics” of the electrified railway on the reactive filter, and prevent the reactive filter and the grid impedance from resonance.

### FIELD OF THE INVENTION

The present invention relates to a type of a hybrid active power filter, and in particular to a hybrid parallel active power filter having a parallel connection for an electrified railway system.

### BACKGROUND INFORMATION

Recently, the widely used locomotives in People's Republic of China are AC electric power locomotives using power frequency rectifiers, (e.g., AC/DC drive locomotives). There are three main existing problems with such locomotives: large harmonic current, low power factor and producing negative sequence current, of which the harmonic current is likely the most prevalent problem.

There may be two basic ways to solve problems of the harmonic current of power locomotives, e.g.: (a) add compensatory equipments, and (b) reconstruct the locomotives to avoid producing harmonic current and make the power factor approach 1. The second method has previously been carried out in several countries. However, it may be almost impossible to reconstruct the AC/DC locomotives that are running. Facing such harmonic current problems that exist in a large number of running electrical locomotives in, e.g., the People's Republic of China, a feasible solution may be to set harmonic current compensatory equipments.

In order to solve the problem of the harmonics current existing in the power supply systems of the electrified railway systems; it may be possible to install the power filters, including the reactive power filters and active power filters. Presently, the reactive power filters have enjoyed a wide-spread usage. However, in order to prevent the reactive power filters and the system impedance from producing resonance and resulting in amplifying of harmonics, it is preferable to design the filters artificially according to a certain frequency deviation so as to ensure the secure operation of the system. Furthermore, due to the existence of the frequency deviations along with the changes of the system impedance parameters and the drifts of the reactive power filter component parameters, it may be difficult for the reactive power filters to achieve the ideal or preferable filtering effects.

There may be two types of uses for the reactive power filters. For example, the first use is its installation in the electrified railway substations, i.e., mainly used to compensate for the reactive power; meanwhile, the third harmonic may by being tuned to about the third harmonic by adding an inductance. The second use is its installation in the locomotives, which is also to compensate for the harmonics by being tuned to the third or fifth harmonics on the basis of reactive power compensation. Both these approaches have played a significant role in practice, but neither provide an affect that is ideal or even preferred for the existing the possible resonance, which may be very difficult to overcome.

One important tendency of harmonics restraint is to adopt the active power filter. The active power filter can achieve better filtering effects than the reactive one, because it can compensate for the harmonics, reactive power and the negative-sequence current dynamically without occurrence of resonance in the system. However, the active power filters have not been widely applied in the People's Republic of China because the separately used active power filter is large in capacity, as well as costly.

### SUMMARY OF THE INVENTION

Thus, in the past, there has been no solution that provides that a LC filtering branch of the reactive filter may be divided into a pure tuning branch and the additional inductance, and then the active power filter is connected to the series-wound inductance in parallel.

In view of the defects and shortcomings of the prior art systems and methods, one of the objects of present invention is to provide a type of a parallel hybrid power filter for the electrified railway system so as to substitute for the common, separately used reactive power filter.

To achieve the above goal, one of the exemplary embodiments of the present invention provides a parallel hybrid power filter apparatus for the electrified railway. The apparatus includes a group of series-wound LC reactive power filters for pure tuning, an inductance arrangement an active power filter, a coupling transformer, and possibly a control system. For example, the active power filter may be connected in parallel to the inductance arrangement via the coupling transformer. One terminal of the filter may be grounded, and the other terminal connected to the power filter so as to form a resultant filtering system. The resultant filtering system may be connected in parallel to a supply entirely.

The power filters and the inductance, as well as the active power filter that is connected in parallel to the inductance arrangement, can be controlled as a current source.

The power filters may include LC series-wound resonant filters for third, fifth and seventh tunings in parallel. The amount of branches may depend on the performance indices of filtering and reactive power.

In the present invention, the parallel hybrid power filter for the electrified railway system may be carried out by modifying the original reactive power filter of fixed frequency deviations into the series connection of the pure tuning LC filtering circuit and the inductance arrangement, controlling the active power filter as a current source, and parallel connecting it to the inductance so as to form the resultant filtering system. In such parallel hybrid power filter apparatus for the electrified railway, the active power filter will likely not add significant cost, but may greatly improve the filtering result. This is because the filter apparatus' capacity is small enough so as to be less than one percent of that of the harmonics source (all the fundamental reactive currents flow into additional inductance Lₐ without flowing through the active filter). The filter apparatus can also inhibit the influence of the “background harmonics” of the electrified railway on the reactive filters, and prevent from resonance between the reactive filter and the power grid, and greatly improve the integral security and reliability of the filtering system. Even if a failure occurs in the active part, the filter apparatus can be automatically disconnected from the system through a fuse, and the reactive filter can still perform the original functions of reactive power and harmonics compensation. Therefore, the control manner of the active filter is simple and reliable.

### BRIEF DESCRIPTION OF THE DRAWINGS

Further objects, features and advantages of the invention will become apparent from the following detailed description taken in conjunction with the accompanying figures showing illustrative embodiments of the invention, in which:

FIG. 1 is a schematic diagram of a hybrid filtering system according to an exemplary embodiment of the present invention;

FIG. 2(a) a circuit diagram of a diagram of a first equivalent circuit of the filtering systems shown in FIG. 1;

FIG. 2(b) a circuit diagram of a diagram of a second equivalent circuit of the filtering systems shown in FIG. 1;

FIG. 2(c) a circuit diagram of a diagram of a third equivalent circuit of the filtering systems shown in FIG. 1;

FIG. 3 is a schematic diagram of a low-power experimental device according to another exemplary embodiment of the present invention;

FIG. 4(a) is an experimental waveform of a source current to be compensated for according to the present invention;

FIG. 4(b) is an experimental waveform of the source current after the reactive filter is connected according to the present invention; and

FIG. 4(c) is an experimental waveform of the source current after the hybrid filtering system is connected according to the present invention.

### DETAILED DESCRIPTION

An exemplary embodiment of a parallel hybrid power filter for electrified railway according to the present invention as well as its operation principles shall be described in further detail below, in conjunction with the attached figures.

According to the present invention, the original reactive power filter with fixed frequency deviations may be provided in a series connection of the LC filtering circuit, e.g., purely for tuning and additional inductance Lₐ. The Filter may control the active power filter (APF) into the current source, and connects it to an additional inductance Lₐ to form the hybrid filtering system. In such exemplary parallel hybrid power filter for the electrified railway, the active power filter APF may not provided additional significant expense, but can greatly improve the filtering result for its capacity is so small as to be less than one percent (1%) of that of the harmonics source (i.e., the fundamental reactive currents flow into additional inductance Lₐ without flowing through the active filter). The filter may also inhibit the impact of the “background harmonics” of the electrified railway on the reactive filter, prevent the reactive filter and the power line impedance from resonance, and can improve the integral security and reliability of the filtering system. Even if a failure occurs with the active part, it can be automatically disconnected from the system through a fuse, and the reactive filter can still perform the original functions of reactive power and harmonics compensation. The control manner of the active filter is simple and reliable.

As shown in FIG. 1, the rightmost load is the power locomotive connected to between the traction line and the ground, a group of LC reactive filter Z_{f} for pure tuning (composed of the paralleled LC series resonant filters, tuned at third, fifth, and seventh harmonic frequency respectively, and the branches are preferably determined by the specific requirements for the filtering and reactive qualities ) is connected to the power supply, and active power filter APF is connected in parallel with additional inductance Lₐ between the reactive filter and the ground via the coupling transformer. The main circuit of the APF adopts the single-phase bridge structure, where an Insulated Gate Bipolar Transistor (IGBT) can be used as the switching device, and its control signals are provided by the drive circuit.

The other symbols in FIG. 1 are introduced as follows:
i_{S}—a source current,
i_{F}—a current flowing through the filtering system, and
i_{L}—the load current.

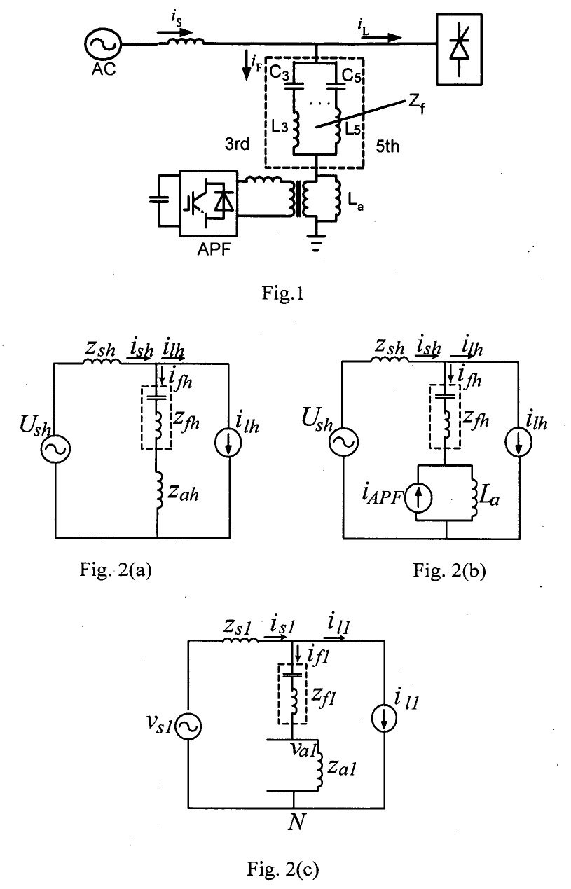

FIGS. 2(a)-(c) show, e.g., equivalent circuits of the hybrid filtering system. For example, the APF may be controlled into controlled as a source current, whose output current is i_{APF} (i_{APF}=kₗ·iₗₕ+kₛ·iₛₕ, iₗₕ and iₛₕ are the harmonic components of the currents of the load current and the source current separately, and kₗ and kₛ are the gain factors of feed-forward and feedback), and the harmonics source can be seen as a current source with Iₗₕ.

When the active filter is not connected, load harmonic current I_{Lh} can be compensated for by the reactive filter. This current can be derived from FIG. 2(a):

$${i}_{sh} = \frac{1}{{z}_{sh} + ( {z}_{fh} + {z}_{ah} )} {v}_{sh} + \frac{( {z}_{fh} + {z}_{ah} )}{{z}_{sh} + ( {z}_{fh} + {z}_{ah} )} {i}_{lh} \qquad ( 1 )$$

where,
Zₛₕ is supply impedance at harmonic frequency,
Z_{fh} is reactive filter impedance at the harmonic frequency,
Zₐₕ is the active filter impedance at the harmonic frequency, and
Vₛₕ is the fimdamental component of the voltage power supply.

If the supply impedance is very small (e.g., |Zₛ|≈0), then, in order to avoid the phenomenon of the harmonics being amplified resulting from the resonance between the reactive filter purely tuned and the supply impedance, inductance Lₐ is connected to the reactive filter purely for tuning in series. Then the whole impedance of the reactive branch will be too large, which leads to the unsatisfactory filtering effect.

After the active filter is connected, it can be controlled as a current source according to the following rule:
i_{APF}=kₗ·iₗₕ+kₛ·iₛₕ (2)

When the active filter is controlled according to the above law, it is derived from FIG. 2b:

$${i}_{sh} = \frac{1}{{z}_{sh} + {z}_{fh} + ( 1 + {k}_{s} ) \cdot {z}_{ah}} {v}_{sh} + \frac{{z}_{fh} + ( 1 - {k}_{l} ) \cdot {z}_{ah}}{{z}_{sh} + {z}_{fh} + ( 1 + {k}_{s} ) \cdot {z}_{ah}} {i}_{lh} \qquad ( 3 )$$

With Z_{fh}≈0, in the feed-forward control, provided that the system will likely not oscillate, gain factor kₗ of the feed-forward control may be 1 (one), and the feedback gain factor of the feedback control can be a bigger(larger) value. It is known from equation (3) that the part of the harmonic supply current that result from the load harmonic current source mainly flow through the filtering branch, and the part result from the harmonic voltage of the electric source are also inhibited to a certain extent by the feedback control.

From FIG. 2c, the following is obtained:

$$\overline{{v}_{a1}} = ( \overline{{v}_{s1}} - {z}_{s1} \cdot \overline{{i}_{l1}} ) \cdot \frac{{z}_{a1}}{{z}_{f1} + {z}_{a1}} \approx \frac{{z}_{a1}}{{z}_{f1} + {z}_{a1}} \cdot \overline{{v}_{s1}} \qquad ( 4 )$$

where,
\overline{Vₐ₁} is the fundamental part of the voltage across Lₐ, i.e., the fundamental voltage added to the active filter, whose value is basically equal to its deserved part after the division between Lₐ and the fundamental impedance of reactive part. The capacity of the active filter is very small for the fundamental currents mainly flows through Lₐ.
zₛ₁ is the equivalent fundamental impedance of the supply; and
z_{f1} is the fundamental impedance of TSF; and
zₐ₁ is the fundamental impedance of additional inductance branch; and
\overline{iₗₕ} is the harmonic load current; and
\overline{iₗ} is the load current.

By analyzing FIGS. (a)-(c), it can be determined that the rate of the capacity active part and capacity of the load is:

$$\frac{{VA}_{APF}}{{VA}_{LOAD}} = \frac{\frac{{z}_{a1}}{{z}_{f1} + {z}_{a1}} \cdot \overline{{v}_{s1}} \cdot \overline{{i}_{lh}}}{\overline{{v}_{s1}} \cdot \overline{{i}_{l}}} = \frac{{z}_{a1}}{{z}_{f1} + {z}_{a1}} \times {THD}_{i} \qquad ( 5 )$$

where,
Zₛ is a supply impedance
Z_{F} is an impedance of TSF
I_{Fh} is a harmonic component of I_{F}
Z_{Sh} is a harmonic supply impedance
THDᵢ is a total harmonic distortion of current

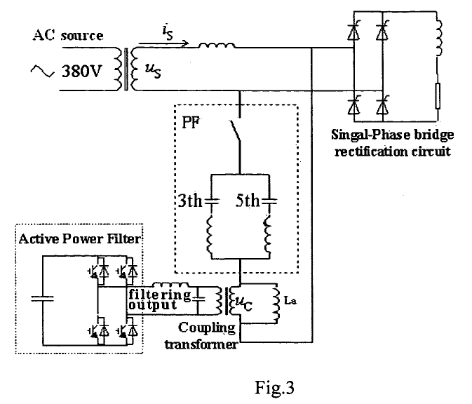

Described is an exemplary embodiment of low power experimental devices according to the present invention which is shown in FIG. 3. Such exemplary device can apply the single-phase full controlled bridge rectifier to simulate the locomotive load. The input voltage is 380V, the output voltage is adjustable between 0V and 500V, and the output current is adjustable between 0A and 60A. The parameters of the reactive filter are as follows: the third filter: L₃=4.65mH, C₃=242 μF; the fifth filter: L₅=3.86 mH, C₅=95 μF; additional inductance Lₐ=0.95 mH. The type of switching device IGBT applied by the active power filter is BSM50GB120DN2.

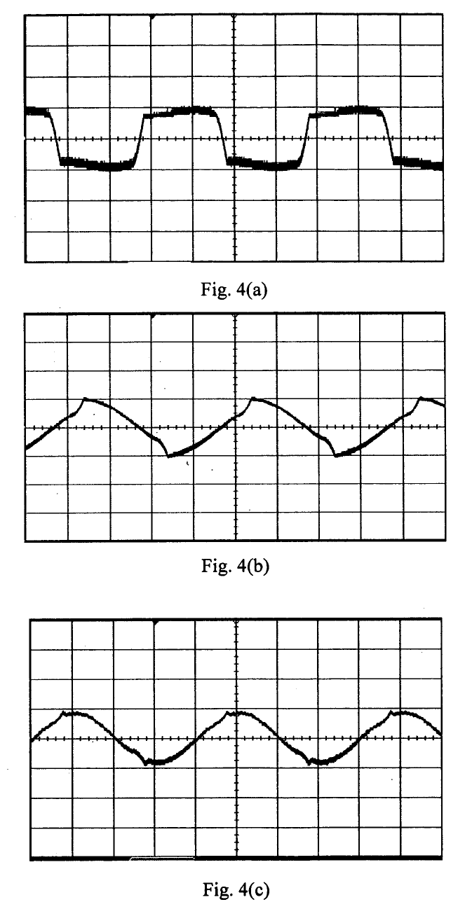

FIGS. 4(a)-(c) show exemplary waveforms generated by the device of FIG. 3. By collating the experimental results shown in FIGS. 4(a)-(c), the following table can be obtained:

TABLE 1
Ratios of the third and fifth harmonics currents to the source currents

| | Comparison Items | |
|---|---|---|
| | Ratio of the third | Ratio of the fifth |
| Comparison | harmonic current to | harmonic current to the |
| Conditions | the fundamental current | fundamental current |
| Uncompensated | 27.31% | 14.73% |
| Reactive filter | 9.12% | 6.31% |
| connected | | |
| Hybrid filtering | 1.96% | 1.32% |
| system connected | | |

As can be seen from such sample experimental results, after the new hybrid filter is connected for compensation, the rations of the third and fifth harmonics in the grid currents drop from 27.31% and 14.73% to 1.96% and 1.32% separately, and the filtering results are fairly good. And, the capacity of the APF is smaller than one percent (1%) of the load capacity of the harmonics source. So, this new type of single-phase hybrid filter is of high practical value.

The foregoing merely illustrates the principles of the invention. Various modifications and alterations to the described embodiments will be apparent to those skilled in the art in view of the teachings herein. It will thus be appreciated that those skilled in the art will be able to devise numerous systems, arrangements and methods which, although not explicitly shown or described herein, embody the principles of the invention and are thus within the spirit and scope of the present invention.

1. A parallel hybrid power filter apparatus for an electrified railway, comprising:
a group of series-wound LC reactive power filters for pure tuning,
an inductance arrangement,
an active power filter, and
a coupling transformer,
wherein the active power filter is connected in parallel to the inductance arrangement via the coupling transformer, one terminal of the transformer being grounded and another terminal being connected to the power filters so as to form a filtering system, and
wherein the filtering system is connected in parallel entirely to a grid.

2. The parallel hybrid power filter apparatus of claim 1, wherein the power filters, the inductance arrangement and the active power filter are controlled in as a current source.

3. The parallel hybrid power filter apparatus of claim 1, wherein the power filters include LC series-wound resonant filters tuned at third, fifth and seventh harmonic frequencies in parallel, and a number of branches depends on performance requirements of a filtering and reactive power compensation.
